(19) United States
(12) Patent Application Publication
(10) Pub. No.: US 2005/0228979 A1
(43) Pub. Date: Oct. 13, 2005

(54) Stored-program device

(75) Inventors: Yosuke Senta, Kawasaki (JP); Shinichi Sazawa, Kawasaki (JP); Yuichi Sato, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/965,778

(22) Filed: Oct. 18, 2004

(30) Foreign Application Priority Data
Apr. 8, 2004 (JP) 2004-114402

(51) Int. Cl. G06F 17/30

(52) U.S. Cl. 713/1

(57) ABSTRACT

A stored-program device includes a disguise-signal transmitting unit that obtains a disguise signal, and transmits the disguise signal to a computer, upon receiving a request from the computer, a program transferring unit that obtains the arbitrary program and transfers the arbitrary program to the computer, and an install controlling unit that controls the disguise-signal transmitting unit to transmit the disguise signal to the computer, and controls the program transferring unit to transfer the arbitrary program to the computer upon receiving a request from a install-program of the computer. The computer installs the arbitrary program transferred by the program transferring unit, using the install-program.

### BACKGROUND OF THE INVENTION

1) Field of the Invention

The present invention relates to a stored-program device that allows an arbitrary program to start by simply inserting the stored-program device into a device interface of a computer.

2) Description of the Related Art

Conventionally, to start a universal serial bus (USB) memory, a compact disc-read only memory (CD-ROM), or the like on a personal computer (PC) having an operating system of Microsoft Windows (registered trademark), all you have to do is to insert such device in a device interface of the PC because the operating system includes a corresponding device driver as standard. On the other hand, to connect a digital camera or a scanner to the PC, a device driver for each device should be installed via a CD-ROM or the Internet because the device drivers for such devices are not provided as standard. Also, it is difficult to obtain the device driver when the CD-ROM storing the device driver is lost or when one tries to use a PC that does not have the device driver a place outside or at an office for using the device.

Conventional technologies regarding a stored-program device are disclosed in, for example, Japanese Patent Laid-Open Publication No. 11-53289, Japanese Patent Laid-Open Publication No. 2000-194645, and Japanese Patent Laid-Open Publication No. 2003-150530.

However, in the above technologies, to allow the device driver stored in the stored-program device to be installed in a PC by using an installing-purpose device driver, the latter device driver has to be installed in advance in the PC. Therefore, the device cannot be used outside or at the office by borrowing a PC that does not have such an installing-purpose device driver.

### SUMMARY OF THE INVENTION

It is an object of the present invention to solve at least the above problems in the conventional technology.

A stored-program device according to one aspect of the present invention, which is connected to a computer having an install-program that is started with a disguise signal as a trigger for installing an arbitrary program stored in a predetermined device, and stores the arbitrary program, includes a disguise-signal transmitting unit that obtains the disguise signal for disguising the stored-program device as the predetermined device, and transmits the disguise signal to the computer, upon receiving a request from the computer; a program transferring unit that obtains the arbitrary program and transfers the arbitrary program to the computer; and an install controlling unit that controls the disguise-signal transmitting unit to transmit the disguise signal to the computer, and controls the program transferring unit to transfer the arbitrary program to the computer upon receiving a request from the install-program. The computer installs the arbitrary program transferred by the program transferring unit, using the install-program.

A method of installing a program according to another aspect of the present invention, which is used for a stored-program device that is connected to a computer having an install-program that is started with a disguise signal as a trigger for installing an arbitrary program stored in a predetermined device, and stores the arbitrary program, includes obtaining the disguise signal for disguising the stored-program device as the predetermined device upon the stored-program device receiving a request from the computer; transmitting the disguise signal to the computer; obtaining the arbitrary program; transferring the arbitrary program to the computer; and controlling the disguise-signal transmitting unit to transmit the disguise signal to the computer and the program transferring unit to transfer the arbitrary program to the computer upon the stored-program device receiving a request from the install-program. The computer installs the arbitrary program transferred at the transferring, using the install-program.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a block diagram of a computer system according to a first embodiment of the present invention;

FIG. 2 is a table for explaining details of an interface descriptor to be transmitted as a disguise signal by a stored-program memory shown in FIG. 1;

FIG. 3 is a flowchart of a process procedure for program installing of the stored-program memory shown in FIG. 1;

FIG. 4 is a block diagram of a computer system according to a second embodiment of the present invention;

FIG. 5 is a flowchart of a process procedure for program installing of a stored-program printer shown in FIG. 4;

FIG. 6 is a block diagram of a computer system according to a third embodiment of the present invention;

FIG. 7 is a flowchart of a process procedure for installing and uninstalling a driver of a stored-program digital camera shown in FIG. 6;

FIG. 8 is a block diagram of a computer system according to a fourth embodiment of the present invention;

FIG. 9 is a flowchart of a process procedure for installing and uninstalling a mail-work environment of a stored-program memory shown in FIG. 8;

FIG. 10 is a block diagram of a computer system according to a fifth embodiment of the present invention; and

FIG. 11 is a flowchart of a process procedure for a version updating of a stored-program memory shown in FIG. 10.

### DETAILED DESCRIPTION

Exemplary embodiments of a stored-program device according to the present invention are explained in detail with reference to the accompanying drawings.

In a first embodiment of the present invention, installing of an arbitrary program stored in a stored-program memory is described. In a second embodiment of the present invention, installing of a device driver stored in a stored-program printer is described. In a third embodiment of the present invention, installing and uninstalling of a device driver stored in a stored-program digital camera is described. In a fourth embodiment of the present invention, installing and uninstalling of a mail-work environment stored in a stored-program memory is described. In a fifth embodiment of the present invention, updating of an arbitrary program stored in a stored-program memory by using a version updating program is described.

According to the first embodiment, installing of an arbitrary program stored in a stored-program memory, such as a USB memory, is described.

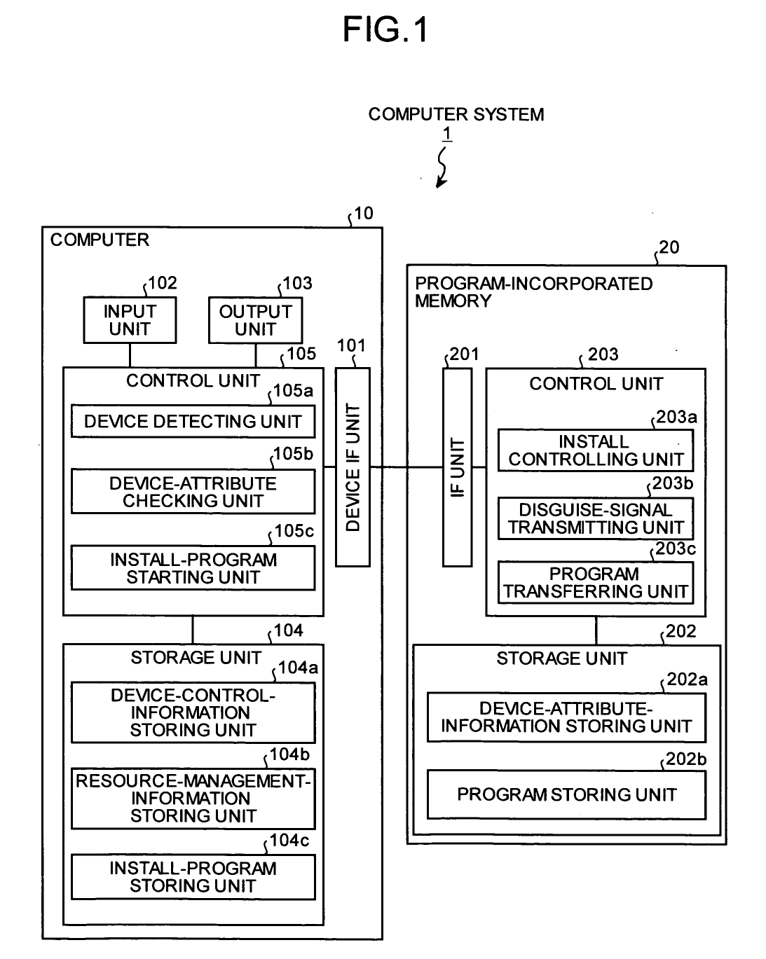

FIG. 1 is a block diagram of a computer system according to the first embodiment. A stored-program memory 20 according to the present invention is implemented by a USB memory that is connected to a computer 10 having an install-program for installing an arbitrary program stored in a predetermined device, and stores the arbitrary program. This memory has a feature of allowing the arbitrary program to start in a simple manner only by being inserted in a device interface unit of the computer 10. Here, the predetermined device is a device whose device driver is provided to an operating system of the computer 10 as standard. An example of the predetermined device is a CD-ROM drive.

A disguise-signal transmitting unit 203b transmits a disguise signal for disguising the memory as the predetermined device, for example, a CD-ROM drive, upon request from the computer 10. A program transferring unit 203c obtains the arbitrary program, and transfers the obtained arbitrary program to the computer 10. An install controlling unit 203a performs control so that the disguise-signal transmitting unit 203b transmits the disguise signal to the computer 10 and, upon request from the install-program started with this disguise signal as a trigger, the program transferring unit 203c transfers the arbitrary program to the computer 10. Thus, with the disguise signal transmitted by the disguise-signal transmitting unit 203b, the computer 10 recognizes the connected stored-program memory 20 as a CD-ROM drive. Therefore, by using the install-program started with this disguise signal as a trigger, the arbitrary program transferred by the program transferring unit 203c from the stored-program memory 20 can be installed. For this reason, only with the device being inserted in a device interface unit 101 of the computer 10, the arbitrary program can be started in a simple manner.

The computer 10 is a PC including the device interface (IF) unit 101, an input unit 102, an output unit 103, a storage unit 104, and a control unit 105. The device IF unit 101 is an input and output interface with the stored-program memory 20, and is implemented by a parallel interface, such as SCSI, or a serial interface, such as USB or IEEE 1394.

The input unit 102 is an input device that inputs a request from a user and data, and is implemented by a keyboard, a mouse, or the like. The output unit 103 is an output device that outputs images and data, and is implemented by an image display device, such as a liquid crystal display (LCD). The storage unit 104 is a storage device, such as a hard disk drive (HDD), and includes a device-control-information storage unit 104a, a resource-management-information storage unit 104b, and an install-program storage unit 104c. The device-control-information storage unit 104a is a storage unit that stores control information for controlling a device connected to the computer 10, and includes device attribute information, which will be separately described further below. The resource-management-information storage unit 104b is a storage unit that stores resource management information for managing the use state of resources, such as an input and output port and an address assigned to the device.

The install-program storage unit 104c is a storage unit that stores an install-program for installing an arbitrary program stored in a predetermined device. Here, the predetermined device is a device whose device driver is provided to an operating system of the computer 10 as standard and, specifically, a CD-ROM drive. For example, the install-program is automatically started upon insertion of a CD-ROM disk, thereby allowing installing of an arbitrary program stored on the CD-ROM disk inserted in the CD-ROM drive.

The control unit 105 is a controlling unit that controls the entire computer 10, and includes a device detecting unit 105a, a device-attribute checking unit 105b, and an install-program starting unit 105c. The device detecting unit 105a is a detecting unit that detects whether a device is connected to a port of the device IF unit 101. The device detecting unit 105a checks to see at predetermined time intervals whether a device is connected to the port of the device IF unit 101.

The device-attribute checking unit 105b is a processing unit that performs a process as follows. When the device detecting unit 105a detects that a device is newly connected to the port of the device IF unit 101, the device-attribute checking unit 105b inquires, for check, of the detected device about device attribute information, which is attribute information for identifying the type and attribute of the device, and then distributes the resources, such as the input and output port and the address, to the device. The install-program starting unit 105c is a processing unit that starts the install-program for installing the arbitrary program stored in the predetermined device.

The stored-program memory 20 is a stored-program device that stores the arbitrary program, and includes an IF unit 201, a storage unit 202, and a controlling unit 203. The IF unit 201 is an input and output interface with the computer 20, and is implemented by a parallel interface, such as SCSI, or a serial interface, such as USB or IEEE 1394.

The storage unit 202 is implemented by a random access memory (RAM), a read only memory (ROM), or the like, and includes a device-attribute-information storage unit 202a and a program storage unit 202b. The device-attribute-information storage unit 202a is a storage unit that stores device attribute information for identifying the type and attribute of the device. The device attribute information will be separately described in detail further below. Also, the program storage unit 202b is a storage unit that stores the arbitrary program.

The controlling unit 203 is implemented by an eight-bit microcomputer, and includes the install controlling unit 203a, the disguise-signal transmitting unit 203b, and the program transferring unit 203c. The disguise-signal transmitting unit 203b is a processing unit that obtains a disguise signal for disguising the device as the predetermined device upon request from the computer 10 and then transmits the disguise signal. The program transferring unit 203c is a processing unit that obtains the arbitrary program, and then transmits the obtained arbitrary program to the computer 10. The install controlling unit 203a is a processing unit that performs control so that the disguise-signal transmitting unit 203b transmits the disguise signal to the computer 10 and, upon request from the install-program started with this controlled disguise signal as a trigger, the program transferring unit 203c transfers the arbitrary program to the computer 10.

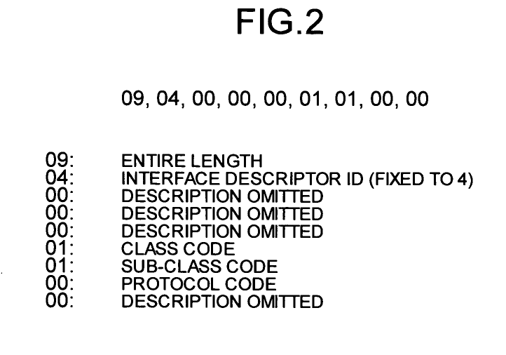

The device attribute information of the stored-program memory 20, such as a USB memory, includes a device descriptor, a configuration descriptor, and an interface descriptor. The device descriptor is information for identifying a manufacturer of the device. The configuration descriptor is information identifying an amount of power consumption and a power function. The interface descriptor is information identifying a type of the device. FIG. 2 is a table for explaining details of an interface descriptor to be transmitted as a disguise signal by a stored-program memory 20 shown in FIG. 1.

The interface descriptor is a sequence of numbers in a decimal notation separated for every two digits. Particularly important for generating a disguise signal are a class code and a sub-class code. A class code of 1 represents an audio-related device, a class code of 3 represents a keyboard or a mouse, a class code of 7 represents a printer, and a class code of 8 represents a storage device. The sub-class code is a code further specifically identifying the device. A sub-class code of 6 represents a small-computer-system-interface (SCSI) device. Therefore, the device with a class code of 8 and a sub-class code of 6 is a SCSI storage device.

Upon reception of a response indicative of a class code of 8 and a sub-class code of 6 from the stored-program memory 20, such as a USB memory, the computer 10 inquires the type of the SCSI storage device, such as an HDD, a magneto-optical (MO) drive, and a CD-ROM drive.

Upon inquiry from the computer 10, the stored-program memory 20 transmits an interface descriptor indicative of a SCSI storage device (or an AT-attachment-packet-interface (ATAPI) device), and further transmits information indicative of a CD-ROM drive, thereby disguising itself as a CD-ROM drive.

Furthermore, to disguise the device as a CD-ROM drive and the actual device, the stored-program memory 20 makes a response indicative of two devices by using a configuration descriptor of the USB device to generate two interface descriptors indicative of the SCSI storage device and the actual device. When the actual device is a SCSI storage device, a SCSI scanner device, or the like, an interface descriptor indicative of a SCSI storage device and a logical unit number (LUN) on a SCSI command are used to indicate the plural functions for response.

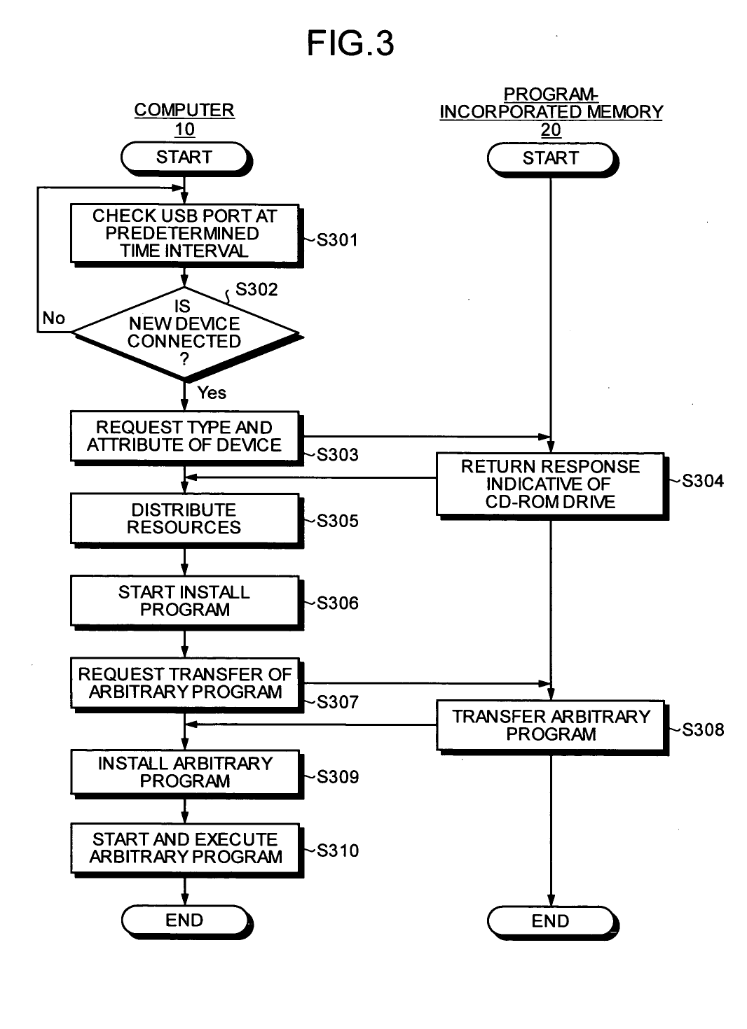

FIG. 3 is a flowchart of a process procedure for program installing of the stored-program memory 20 shown in FIG. 1. As shown in the drawing, the computer 10 checks a USB port at predetermined time intervals (step S301) to see whether a new device is connected (step S302).

If a new device is not connected (“NO” at step S302), the device detecting unit 105a of the computer 10 returns to step S301. Meanwhile, if a new device is connected (“YES” at step S302), the device-attribute checking unit 105b of the computer 10 requests the stored-program memory 20 to provide the type and attribute of the device (step S303). Furthermore, upon request from the computer 10, the install controlling unit 203a of the stored-program memory 20 performs control so that the disguise-signal transmitting unit 203b transmits the disguise signal for disguising the device as a CD-ROM drive, that is, the interface descriptor shown in FIG. 2 containing information for disguising the device as a CD-ROM drive (step S304).

The computer 10 then receives the disguise signal from the stored-program memory 20 to recognize that the stored-program memory 20 is a CD-ROM drive, and then distributes the resources, such as the input and output port and the address (step S305). Next, the computer 10 starts the install-program (step S306), and then requests the stored-program memory 20 to transfer the arbitrary program (step S307). Furthermore, the install controlling unit 203a of the stored-program memory 20 performs control so that the program transferring unit 203c transfers the arbitrary program to the computer 10 (step S308).

The computer 10 then installs the arbitrary program transferred from the stored-program memory 20 (step S309) to start and execute the program (step S310). In this manner, according to this procedure, only with the stored-program memory 20 being connected to the device IF unit 101 of the computer 10, the arbitrary program stored in the stored-program memory 20 can be installed.

As described above, according to the first embodiment, the disguise-signal transmitting unit 203b transmits, upon request from the computer 10, a disguise signal for disguising the device as the predetermined device. The program transferring unit 203c obtains an arbitrary program, and then transfers the obtained arbitrary program to the computer 10. The install controlling unit 203a performs control so that the disguise-signal transmitting unit 203b transmits the disguise signal to the computer 10 and the program transferring unit 203c transmits the arbitrary program to the computer 10 upon request from the install-program started with this controlled disguise signal as a trigger. Therefore, the computer 10 can install the arbitrary program transferred by the program transferring unit 203c from the stored-program memory 20 by using the install-program started with the disguise signal transmitted by the disguise-signal transmitting unit 203b as a trigger. Thus, only with the device being inserted in the device interface unit of the computer 10, the arbitrary program can be started in a simple manner.

Also, the predetermined device is a device whose device driver is provided to the operating system of the computer 10 as standard. Therefore, for example, only with the device being inserted in the device interface unit 101 of the computer 10 and disguising itself as a CD-ROM drive, the arbitrary program can be started in a simple manner.

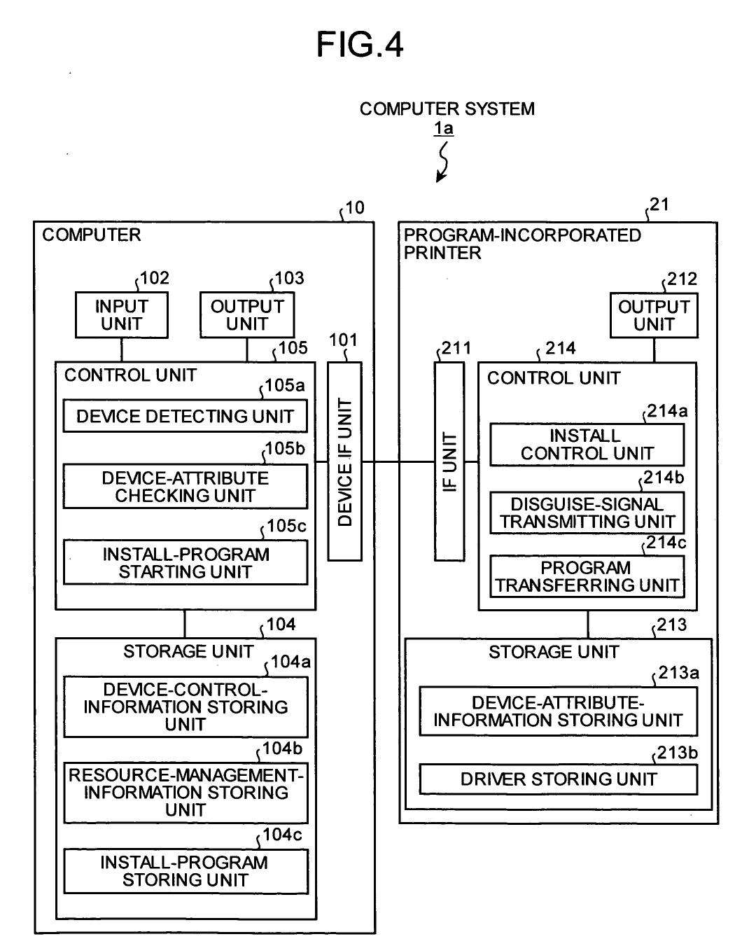

FIG. 4 is a block diagram of a computer system according to the second embodiment. FIG. 4 is different from the block diagram of FIG. 1 in a stored-program printer 21. Here, details shared in common by the first embodiment are not described, and only different points are described.

The stored-program printer 21 is a stored-program device that stores a device driver, and includes an IF unit 211, an output unit 212, a storage unit 213, and a controlling unit 214. The IF unit 211 is an input and output interface with the computer 20, and is implemented by a parallel interface, such as SCSI, or a serial interface, such as USB or IEEE 1394.

The output unit 212 is a printing mechanism for sequentially printing output data of the computer 10. The storage unit 213 is implemented by a RAM, a ROM, or the like, and includes a device-attribute-information storage unit 213a and a driver storage unit 213b. The device-attribute-information storage unit 213a is a storage unit that stores device attribute information for identifying the type and attribute of the device. The device attribute information has been described in detail in the first embodiment. The program storage unit 213b is a storage unit that stores the device driver for driving the stored-program printer 21.

The controlling unit 214 is implemented by an eight-bit microcomputer, and includes an install controlling unit 214a, a disguise-signal transmitting unit 214b, and a program transferring unit 214c. The disguise-signal transmitting unit 214b is a processing unit that obtains a disguise signal for disguising the device as a predetermined device upon request from the computer 10 and then transmits the obtained disguise signal. The program transferring unit 214c is a processing unit that obtains the arbitrary program and then transmits the obtained arbitrary program to the computer 10. The install controlling unit 214a performs control so that the disguise-signal transmitting unit 214b transmits the disguise signal to the computer 10 and the program transferring unit 214c transfers the arbitrary program to the computer 10 upon request from the install-program started with the controlled disguise signal as a trigger.

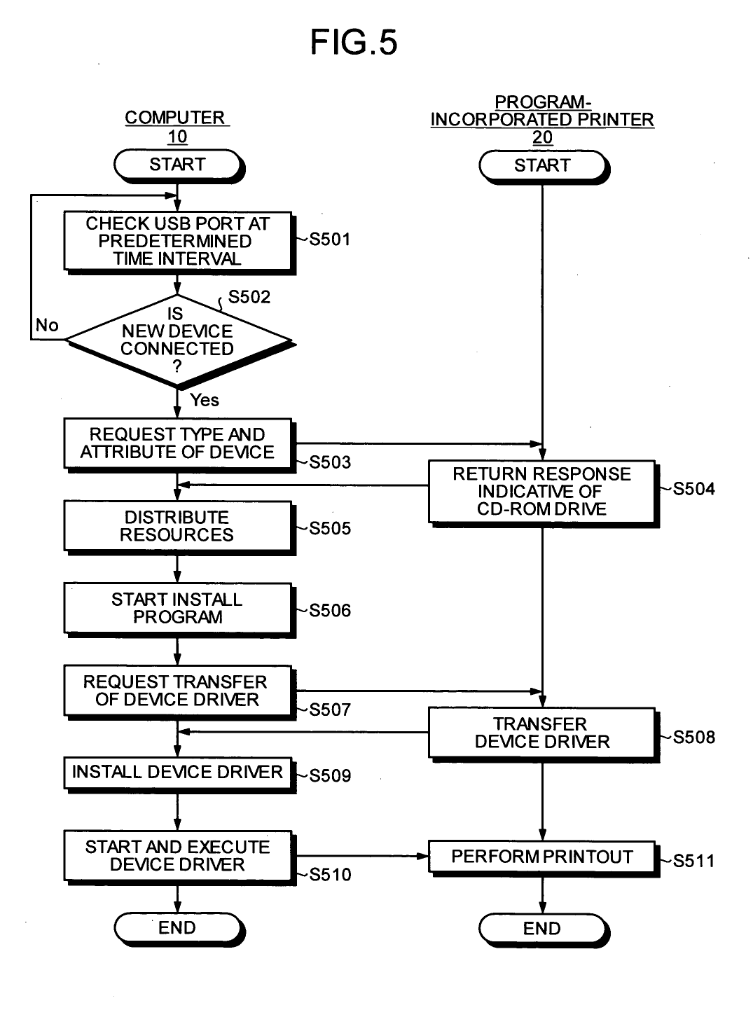

FIG. 5 is a flowchart of a process procedure for program installing of a stored-program printer 21 shown in FIG. 4. The computer 10 checks the USB port at predetermined time intervals (step S501) to see whether a new device is connected (step S502).

If a new device is not connected (“NO” at step S502), the device detecting unit 105a of the computer 10 returns to step S501. Meanwhile, if a new device is connected (“YES” at step S502), the device-attribute checking unit 105b of the computer 10 requests the stored-program printer 21 to provide the type and attribute of the device (step S503). Furthermore, the install controlling unit 214a of the stored-program printer 21 performs control so that, upon request from the computer 10, the disguise-signal transmitting unit 214b transmits a disguise signal for disguising the device as a CD-ROM drive, that is, the interface descriptor shown in FIG. 2 (step S504).

The computer 10 then receives the disguise signal from the stored-program printer 21 to recognize that the stored-program printer 21 is a CD-ROM drive, and then distributes the resources, such as the input and output port and the address (step S505). Next, the computer 10 starts the install-program (step S506), and then requests the stored-program printer 21 to transfer the device driver (step S507). Furthermore, the install controlling unit 214a of the stored-program printer 21 performs control so that the program transferring unit 214c transfers the program to the computer 10 (step S508).

The computer 10 then installs the device driver transferred from the stored-program printer 21 (step S509) to start and execute the program (step S510), thereby causing the stored-program printer 21 to perform printout (step S511). In this manner, according to this procedure, only with the stored-program printer 21 being connected to the device IF unit 101 of the computer 10, the device driver stored in the stored-program printer 21 can be installed, thereby causing the program-integrated printer 21 to operate.

As described above, according to the second embodiment, the disguise-signal transmitting unit 214b transmits, upon request from the computer 10, a disguise signal for disguising the device as the predetermined device. The program transferring unit 214c obtains an arbitrary program, and then transfers the obtained arbitrary program to the computer 10. The install controlling unit 214a performs control so that the disguise-signal transmitting unit 214b transmits the disguise signal to the computer 10 and the program transferring unit 214c transmits the arbitrary program to the computer 10 upon request from the install-program started with this controlled disguise signal as a trigger. Therefore, the computer 10 can install the arbitrary program transferred the program transferring unit 214c from the stored-program printer 21 by using the install-program started with the disguise signal transmitted by the disguise-signal transmitting unit 214b as a trigger. Thus, only with the device being inserted in the device interface unit 101 of the computer 10, the arbitrary program can be started in a simple manner.

Also, the arbitrary program is a device driver for operating the stored-program printer 21. Therefore, for example, only with the device being inserted in the device interface unit 101 of the computer 10 and disguising itself as a CD-ROM drive, the device driver can be started in a simple manner, thereby causing the stored-program printer 21 to operate.

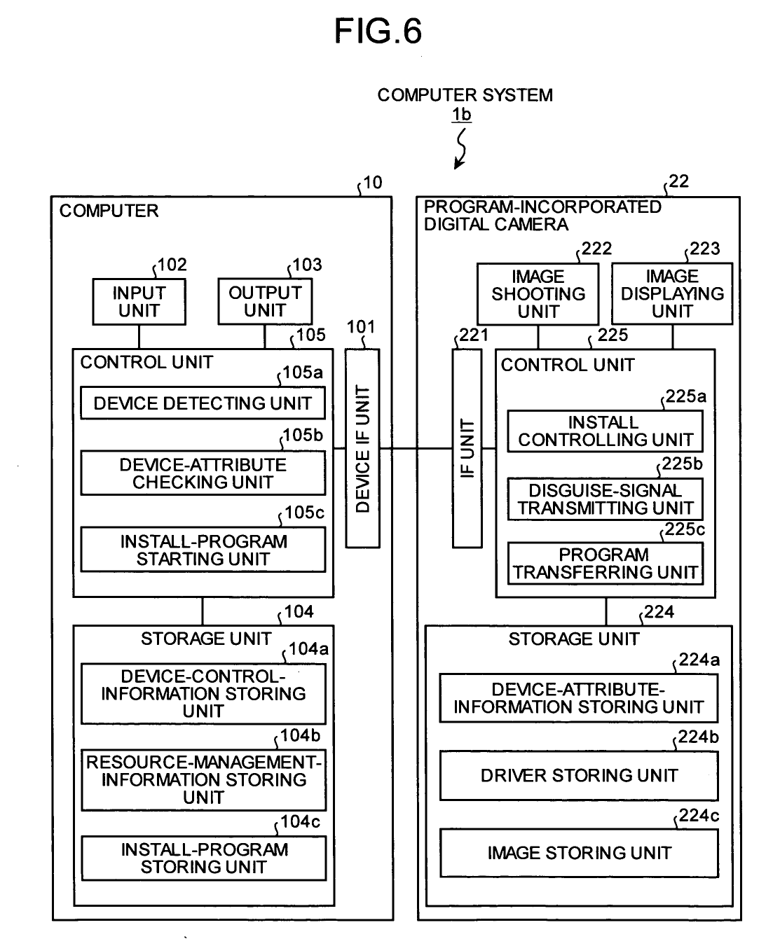

FIG. 6 is a block diagram of a computer system according to the third embodiment. FIG. 6 is different from the block diagram of FIG. 1 in a stored-program digital camera 22. Here, details shared in common by the first embodiment are not described, and only different points are described.

The stored-program digital camera 22 is a stored-program device that stores a device driver, and includes an IF unit 221, an image shooting unit 222, an image displaying unit 223, a storage unit 224, and a controlling unit 225. The IF unit 221 is an input and output interface with the computer 10, and is implemented by a parallel interface, such as SCSI, or a serial interface, such as USB or IEEE 1394.

The image shooting unit 222 is a shooting unit for shooting an image. The image displaying unit 223 is a display unit for displaying the image shot by the image shooting unit 222 as a still image or a moving image. The storage unit 224 is implemented by a RAM, a ROM, or the like, and includes a device-attribute-information storage unit 224a, a driver storage unit 224b, and an image storage unit 224c. The device-attribute-information storage unit 224a is a storage unit that stores device attribute information for identifying the type and attribute of the device. The device attribute information has been described in detail in the first embodiment. The driver storage unit 224b is a storage unit that stores the device driver for driving the stored-program digital camera 22. The image storage unit 224c is a storage unit that stores image data shot by the image shooting unit 222.

The controlling unit 225 is implemented by an eight-bit microcomputer, and includes an install controlling unit 225a, a disguise-signal transmitting unit 225b, and a program transferring unit 225c. The disguise-signal transmitting unit 225b is a processing unit that obtains a disguise signal for disguising the device as a predetermined device upon request from the computer 10 and then transmits the obtained disguise signal. The program transferring unit 225c is a processing unit that obtains the arbitrary program and then transmits the obtained arbitrary program to the computer 10. The install controlling unit 225a performs control so that the disguise-signal transmitting unit 225b transmits the disguise signal to the computer 10 and the program transferring unit 225c transfers the arbitrary program to the computer 10 upon request from the install-program started with the controlled disguise signal as a trigger.

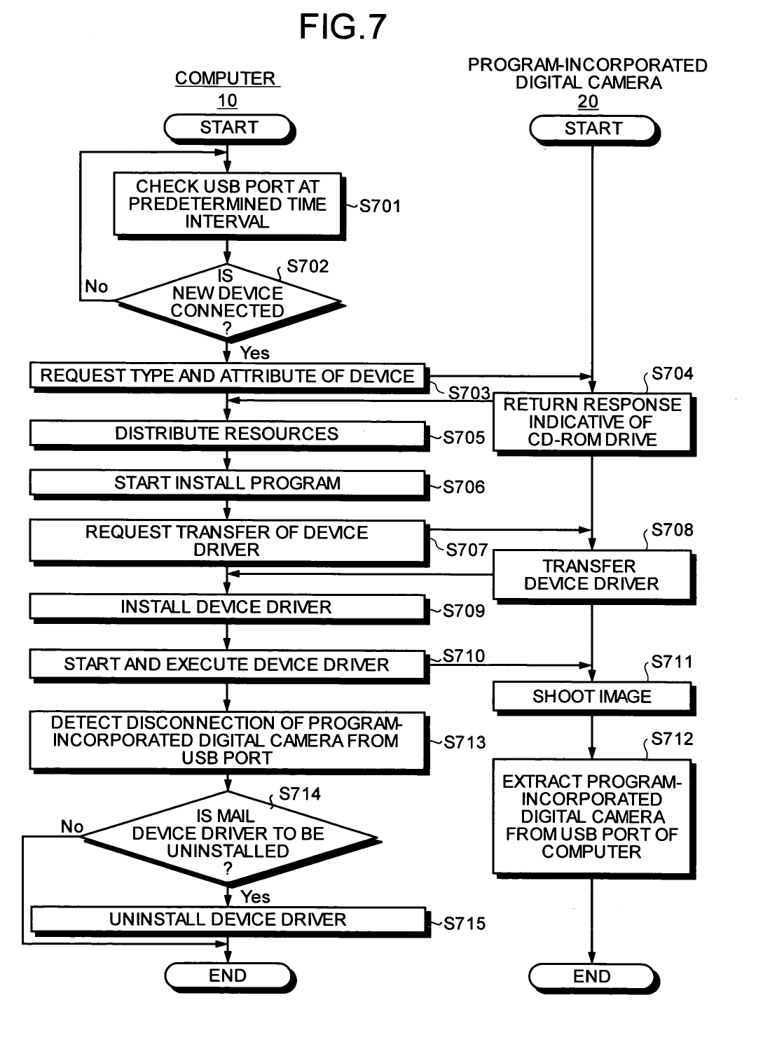

FIG. 7 is a flowchart of a process procedure for installing and uninstalling a driver of a stored-program digital camera 22 shown in FIG. 6. As shown in the drawing, the computer 10 checks the USB port at predetermined time intervals (step S701) to see whether a new device is connected (step S702).

If a new device is not connected (“NO” at step S702), the device detecting unit 105a of the computer 10 returns to step S701. Meanwhile, if a new device is connected (“YES” at step S702), the device-attribute checking unit 105b of the computer 10 requests the stored-program digital camera 22 to provide the type and attribute of the device (step S703). Furthermore, upon request from the computer 10, the install controlling unit 225a of the stored-program digital camera 22 performs control so that the disguise-signal transmitting unit 225b transmits the disguise signal for disguising the device as a CD-ROM drive, that is, the interface descriptor shown in FIG. 2 (step S704).

The computer 10 then receives the disguise signal from the stored-program digital camera 22 to recognize that the stored-program digital camera 22 is a CD-ROM drive, and then distributes the resources, such as the input and output port and the address (step S705). Next, the computer 10 starts the install-program (step S706), and then requests the stored-program digital camera 22 to transfer the device driver (step S707). Furthermore, the install controlling unit 225a of the stored-program digital camera 22 performs control so that the program transferring unit 225c transfers the arbitrary program to the computer 10 (step S708).

The computer 10 then installs the device driver transferred from the stored-program digital camera 22 (step S709) to start and execute the device driver (step S710), thereby causing the stored-program digital camera 22 to shoot an image (step S711).

After image shooting in the manner described above, when the stored-program digital camera 22 is disconnected from the USB port of the computer 10 (step S712), the computer 10 detects the disconnection of the stored-program digital camera 22 from the USB port of the computer 10 (step S713), and then checks whether to uninstall the device driver (step S714). As a result, if the device driver is to be uninstalled (“YES” at step S714), the computer 10 uninstalls the device driver (step S715).

Meanwhile, if the device driver is not to be uninstalled (“NO” at step S714), the computer 10 ends the procedure. In this manner, according to this procedure, only with the stored-program digital camera 22 being connected to the device IF unit 101 of the computer 10, the device driver stored in the stored-program digital camera 22 can be installed, thereby causing the stored-program digital camera 22 to operate. Also, only with the stored-program digital camera 22 being disconnected from the device IF unit 101 of the computer 10, the device driver can be uninstalled.

As described above, according to the third embodiment, the disguise-signal transmitting unit 225b transmits, upon request from the computer 10, a disguise signal for disguising the device as the predetermined device. The program transferring unit 225c obtains an arbitrary program, and then transfers the obtained arbitrary program to the computer 10. The install controlling unit 225a performs control so that the disguise-signal transmitting unit 225b transmits the disguise signal to the computer 10 and the program transferring unit 225c transmits the arbitrary program to the computer 10 upon request from the install-program started with this controlled disguise signal as a trigger. Therefore, the computer 10 can install the arbitrary program transferred by the program transferring unit 225c from the stored-program digital camera 22 by using the install-program started with the disguise signal transmitted by the disguise-signal transmitting unit 225b as a trigger. Thus, only with the device being inserted in the device interface unit 101 of the computer 10, the arbitrary program can be started in a simple manner.

Also, the predetermined program is a device driver that causes the program-integrated digital camera 22 to operate. Therefore, for example, only with the device being inserted in the device interface unit 101 of the computer 10 and disguising itself as a CD-ROM drive, the device driver can be started in a simple manner, thereby causing the stored-program digital camera 22 to operate.

Furthermore, the device driver is uninstalled with the program-integrated digital camera 22 being disconnected from the computer 10 as a trigger. Therefore, the device driver can be uninstalled only with the stored-program digital camera 22 being disconnected from the device IF unit 101 of the computer 10.

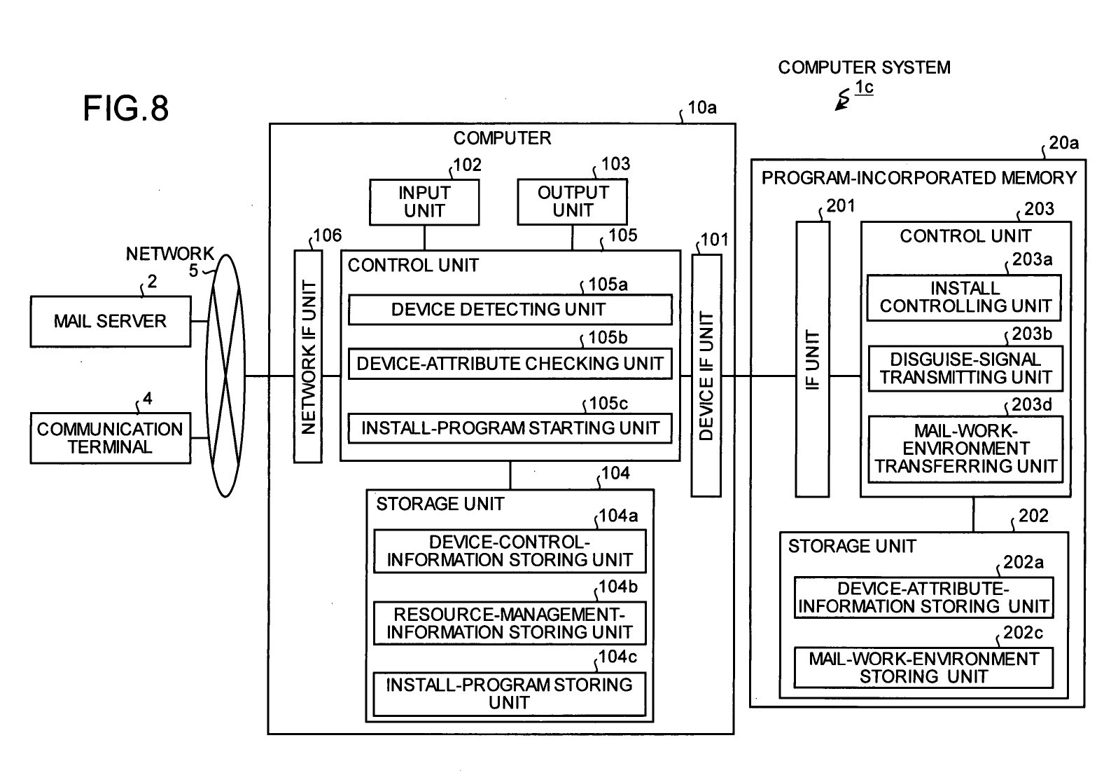

FIG. 8 is a block diagram of a computer system according to the fourth embodiment. FIG. 8 is different from the block diagram of FIG. 1 in a mail server apparatus 2, a communication terminal 4, a network 5, a network IF unit 106 of a computer 10a, a mail-work-environment storage unit 202c of a stored-program memory 20a, and a mail-work-environment transferring unit 203d. Here, details shared in common by the first embodiment are not described, and only different points are described.

The mail server apparatus 2 is a server that delivers an electronic mail transmitted from the computer 10a to the communication terminal 4 designated with a mail address, and distributes an electronic mail delivered from the communication terminal 4 to the computer 10a. The communication terminal 4 communicates with the computer 10a. The network 5 is a communication network for communications according to the transmission control protocol/Internet protocol (TCP/IP), and is a dedicated line for the Internet or a provider.

The network IF unit 106 of the computer 10a is a communication interface for communications with the mail server apparatus 2 and the communication terminal 4 via the network 5, and is specifically implemented by a network interface card.

The mail-work-environment storage unit 202c of the stored-program memory 20a is a storage unit that stores information about a work environment required for transmission and reception of electronic mails. The mail-work environment includes address information of the mail server apparatus 4, such as a simple-mail-transport-protocol (SMTP) server or a post-office-protocol (POP) server, user identification information, address information, password, address book, and mail log. The mail-work-environment transferring unit 203d is a processing unit that transfers the mail-work environment to the computer 10a.

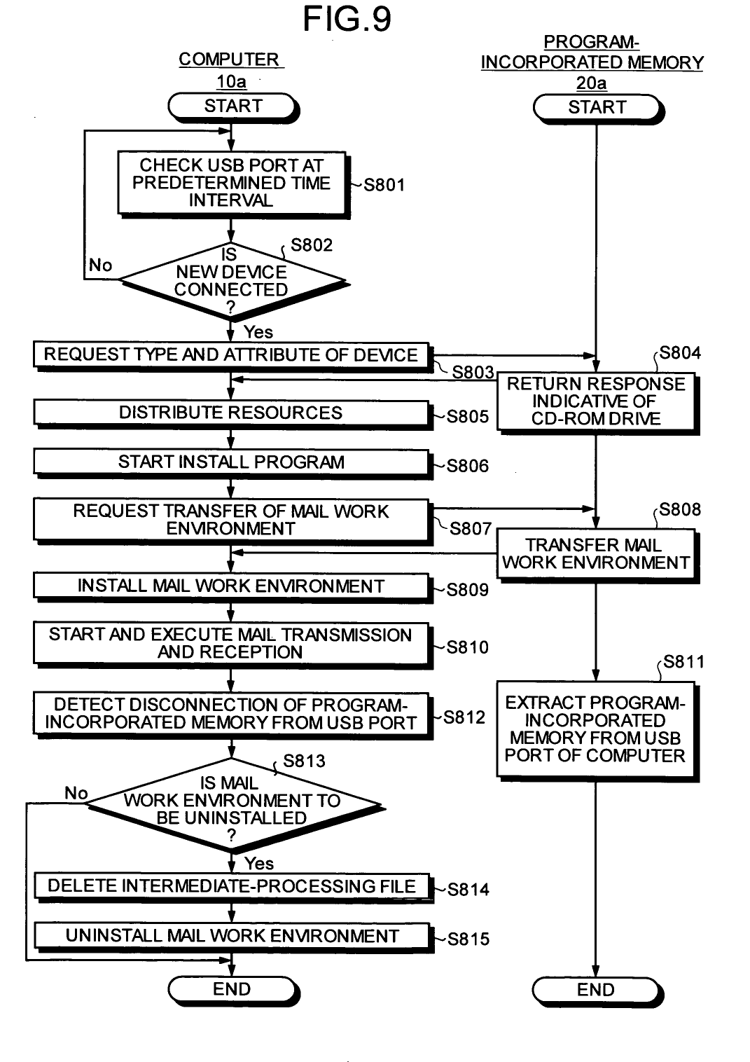

FIG. 9 is a flowchart of a process procedure for installing and uninstalling a mail-work environment of a stored-program memory 20a shown in FIG. 8. Here, processes at steps S801 through S806 in FIG. 9 are exactly identical to processes at steps S301 through S306 in FIG. 3 according to the first embodiment. Therefore, only the other processes at steps S807 through S815 are described.

The computer 10a requests the stored-program memory 20a to transfer a mail-work environment (step S807). Furthermore, the install controlling unit 203a of the stored-program memory 20a performs control so that the mail-work-environment transferring unit 203d transfers the mail-work environment to the computer 10a (step S808). The computer 10a then installs the mail-work environment transferred from the stored-program memory 20a (step S809), and then starts and executes mail transmission and reception (step S810).

After electronic-mail transmission and reception, when the stored-program memory 20a is disconnected from the USB port of the computer 10a (step S811), the computer 10a detects the disconnection of the stored-program memory 20a from the USB port of the computer 10a (step S812) to check whether the mail-work environment is to be uninstalled (step S813). As a result, if the mail-work environment is to be uninstalled (“YES” at step S813), the computer 10a deletes an intermediate-processing file (step S814) to uninstall the mail-work environment (step S815).

Meanwhile, if the mail-work environment is not to be uninstalled (“NO” at step S813), the computer 10a ends the procedure. In this manner, according to this procedure, only with the stored-program memory 20a being connected to the device IF unit 101 of the computer 10a, the mail-work environment stored in the stored-program memory 20a can be installed. Also, the mail-work environment can be uninstalled only with the stored-program memory 20a being disconnected from the device IF unit 101 of the computer 10a.

As described above, according to the fourth embodiment, the arbitrary program is either one of a work environment and a development environment regarding an application program executable on the computer. Therefore, the computer 10a can install the work environment transferred by the mail-work-environment transferring unit 203d from the stored-program memory 20a by using the install-program started with the disguise signal transmitted by the disguise-signal transmitting unit 203b as a trigger. Thus, only with the stored-program memory 20a being inserted in the device interface unit 101 of the computer 10a, the mail-work environment can be installed in a simple manner.

Also, the mail-work environment is uninstalled with the program-integrated memory 20a being disconnected from the computer 10a as a trigger. Therefore, the mail-work environment can be uninstalled only with the stored-program memory 20a being disconnected from the device IF unit 101 of the computer 10a.

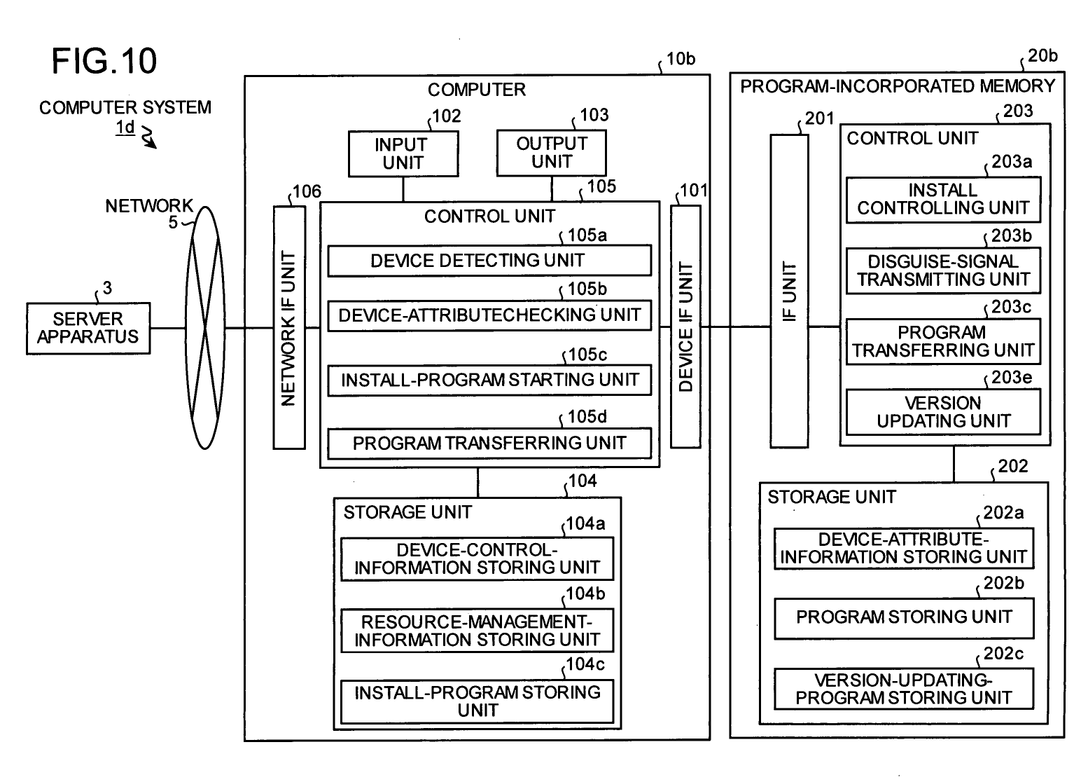

FIG. 10 is a block diagram of a computer system according to the fifth embodiment. FIG. 10 is different from the block diagram according to the first embodiment in a server apparatus 3, a network 5, a network IF unit 106 of a computer 10b, a program transferring unit 105d, a version-updating-program storage 202d of a stored-program memory 20b, and a version updating unit 203e. Here, details shared in common by the first embodiment are not described, and only different points are described.

The server apparatus 3 is a server that transmits the latest version of an arbitrary program to the computer 10b upon request from the computer 10b. The network 5 is a communication network for communications according to the TCP/IP, and is a dedicated line for the Internet or a provider.

The network IF unit 106 of the computer 10b is a communication interface for communicating with the server apparatus 3 via the network 5, and is specifically implemented by a network interface card.

The version-updating-program storage unit 202d of the stored-program memory 20b is a storage unit that stores a version updating program for managing version information of the arbitrary program and obtaining the latest version of the arbitrary program from the server apparatus 3 via the network 5 connected to the computer 10b for transfer to the stored-program memory 20b. The version updating unit 203e is a processing unit that updates the arbitrary program stored in the program storage unit 202b with the latest version of the arbitrary program transferred from the computer 10b.

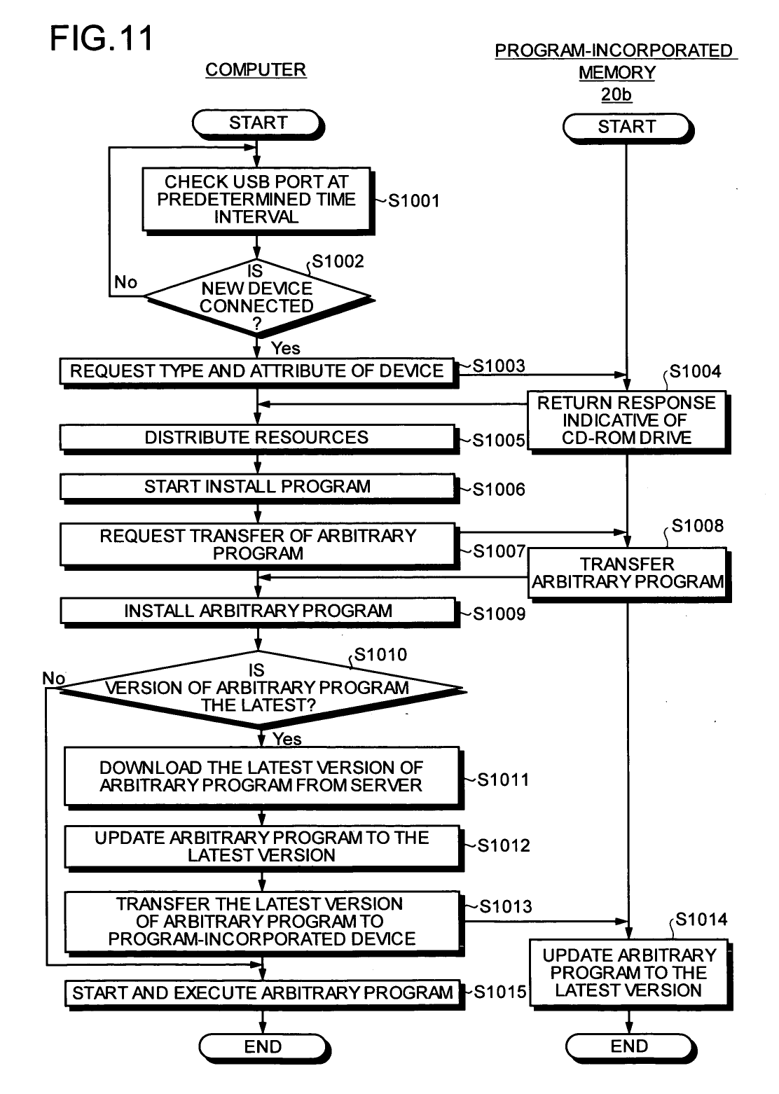

FIG. 11 is a flowchart of a process procedure for a version updating of a stored-program memory 20b shown in FIG. 10. Here, processes at steps S1001 through S1009 in FIG. 11 are exactly identical to processes at steps S301 through S309 in FIG. 3 according to the first embodiment. Therefore, only the other processes at steps S1010 through S1015 are described.

The computer 10b checks whether the version of the arbitrary program is the latest (step S1010). As a result, if the version of the arbitrary program is the latest (“YES” at step S1010), the computer 10b starts and executes the arbitrary program (step S1015).

Meanwhile, if the version of the arbitrary program is not the latest (“NO” at step S1010), the computer 10b downloads the latest version of the arbitrary program from the server apparatus 3 via the network 5 (step S1011) to update the arbitrary program to the latest version (step S1012). The computer 10b then transfers the latest version of the arbitrary program to the stored-program memory 20b (step S1013). Furthermore, the version updating unit 203e updates the arbitrary program stored in the program storage unit 202d with the latest version of the arbitrary program transferred from the computer 10b (step S1014).

In this manner, according to this procedure, only with the stored-program memory 20b being connected to the device IF unit 101 of the computer 10b, the version updating program stored in the stored-program memory 20b can be installed for start and execution, thereby updating the arbitrary program.

As described above, according to the fifth embodiment, the version-updating-program storage unit 202d is a storage unit that stores a version updating program for managing version information of the arbitrary program and obtaining the latest version of the arbitrary program via the network connected to the computer 10b to update the old version of the arbitrary program with the obtained latest version. The computer 10b can install the version updating program transferred by the program transferring unit 203c from the stored-program memory 20b by using the install-program started with the disguise signal transmitted by the disguise-signal transmitting unit 203b as a trigger.

Here, while the embodiments of the present invention have been described, the present invention can be achieved by various different embodiments other than the embodiments described above within the scope of the technical ideas described in claims.

For example, in the description of the fourth embodiment, the present invention is applied to installing of a mail-work environment. However, the present invention is not restricted to be applied to this, and can also be applied to installing of a software development environment.

Also, in the description of the first to fourth embodiments, the present invention is applied to the case where the user freely uses the stored-program device. However, the present invention is not restricted to be applied to this, and can also be applied to the case where an authenticating unit is provided for preventing unauthorized use of the stored-program device. For example, biometrics and identification by using fingerprints and retinas can be applied.

According to a first aspect of the present invention, an arbitrary program can be started in a simple manner only with a device being inserted in a device interface unit of a computer.

According to a second aspect of the present invention, only with a device being inserted in a device interface unit of a computer and disguising the device as, for example, a CD-ROM drive, an arbitrary program can be started in a simple manner.

According to a third aspect of the present invention, only with a device being inserted in a device interface unit of a computer and disguising the device as, for example, a CD-ROM drive, a device driver can be started in a simple manner, and a stored-program printer can be operated.

According to a fourth aspect of the present invention, a computer can install a work environment or a development environment transferred from a stored-program device by using a install-program that is started with a disguise signal transmitted as a trigger, and starts an application program in a simple manner only with the device being inserted in a device interface unit of the computer.

According to a fifth aspect of the present invention, the arbitrary program is uninstalled with the stored-program device being disconnected from the computer as a trigger. Therefore, an effect can be achieved such that the program can be uninstalled only with the stored-program device being disconnected from the device IF unit of the computer.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

1. A stored-program device that is connected to a computer having an install-program that is started with a disguise signal as a trigger for installing an arbitrary program stored in a predetermined device, the stored-program device storing the arbitrary program, the stored-program device comprising:
a disguise-signal transmitting unit that obtains the disguise signal for disguising the stored-program device as the predetermined device, and transmits the disguise signal to the computer, upon receiving a request from the computer;
a program transferring unit that obtains the arbitrary program and transfers the arbitrary program to the computer; and
an install controlling unit that controls the disguise-signal transmitting unit to transmit the disguise signal to the computer, and controls the program transferring unit to transfer the arbitrary program to the computer upon receiving a request from the install-program, wherein
the computer installs the arbitrary program transferred by the program transferring unit, using the install-program.

2. The stored-program device according to claim 1, wherein the predetermined device is a device whose device driver is incorporated in an operating system of the computer as standard.

3. The stored-program device according to claim 1, wherein the arbitrary program is a device driver that operates the stored-program device.

4. The stored-program device according to claim 1, wherein the arbitrary program is either of a work environment and a development environment for an application program executable on the computer.

5. The stored-program device according to claim 1, wherein the arbitrary program is uninstalled when the stored-program device is disconnected from the computer.

6. The stored-program device according to claim 1, further comprising a version-updating-program storage unit that stores a version updating program that manages version information of the arbitrary program, obtains a latest version of the arbitrary program via a network connected to the computer, and updates an old version of the arbitrary program with the latest version, wherein
the computer installs the version updating program transferred by the program transferring unit, using the install-program.

7. The stored-program device according to claim 1, further comprising an authenticating unit that verifies whether a user of the stored-program device is authenticated to use the stored-program device at the time of starting the stored-program device.

8. A method of installing a program used for a stored-program device that is connected to a computer having an install-program that is started with a disguise signal as a trigger for installing an arbitrary program stored in a predetermined device, the stored-program device storing the arbitrary program, the method comprising:
obtaining the disguise signal for disguising the stored-program device as the predetermined device upon the stored-program device receiving a request from the computer;
transmitting the disguise signal to the computer;
obtaining the arbitrary program;
transferring the arbitrary program to the computer; and
controlling the disguise-signal transmitting unit to transmit the disguise signal to the computer and the program transferring unit to transfer the arbitrary program to the computer upon the stored-program device receiving a request from the install-program, wherein
the computer installs the arbitrary program transferred at the transferring, using the install-program.

9. The method according to claim 8, wherein the predetermined device is a device whose device driver is incorporated in an operating system of the computer as standard.

10. The method according to claim 8, wherein the arbitrary program is either of a work environment and a development environment for an application program executable on the computer.
